(19) United States
(12) Patent Application Publication
(10) Pub. No.: US 2004/0144200 A1
(43) Pub. Date: Jul. 29, 2004

(54) Torsional damper coupling

(76) Inventors: James R. Giordano, Sterling Heights, MI (US); Jamin A. Buss, Sterling Heights, MI (US); John Cavataio, Macomb, MI (US)

Correspondence Address: HARNESS, DICKEY & PIERCE, P.L.C., P.O. BOX 828, BLOOMFIELD HILLS, MI, 48303, US

(21) Appl. No.: 10/351,594

(22) Filed: Jan. 24, 2003

(51) Int. Cl. F16F 15/10

(52) U.S. Cl. 74/574

(57) ABSTRACT

A torsional damper coupling for dampening torsional vibration between a prime mover and a dynamometer. The torsional damper coupling includes a compression ring with a plurality of pockets that retain a plurality of spring members. The compression member is disposed between body and cover members that each have a plurality of recesses that retain a portion of the spring members. The compression member is coupled to one of a prime mover and a dynamometer while the body member is coupled to the other of the prime mover and dynamometer. Torsional vibration caused by the prime mover is dampened by the spring members which resist relative movement between the compression member and the body member. The spring members are readily available off-the-shelf coil springs. A solid ring bearing couples the compression member to the body member and facilitates relative movement between the body member and the compression member.

### FIELD OF THE INVENTION

The present invention relates generally to a torsional damper coupling, and more particularly, to a torsional damper coupling for damping torsional vibration between a dynamometer and a combustion engine or prime mover.

### BACKGROUND OF THE INVENTION

Dynamometers are used generally for measuring the performance of rotating machinery including combustion engines and drive trains which are alternately referred to herein as prime movers. The automotive industry, for example, uses dynamometers to measure a variety of engine parameters related to vehicle combustion engine performance including output torque and horsepower during engine testing which often lasts several hundreds of engine operating hours. The dynamometer testing is generally performed over engine operating speeds ranging between idle and maximum rated speed and under different loading conditions. The advent of smaller, lighter weight and more fuel efficient automotive engines has resulted in a tendency toward higher engine operating speeds, which are required to perform the same as did larger predecessor engines. In modern automotive engines, speeds range between approximately 600 rpm at idle to greater than 10,000 rpm depending on engine size and application.

In a typical engine dynamometer test configuration, an output shaft of the engine is coupled to an input shaft of the dynamometer. A torsional damper coupling is disposed, or interconnected, between the dynamometer and the engine. The torsional damper coupling isolates the dynamometer from engine induced vibration, and in particular from torsional vibration resulting primarily from pulses during combustion engine power strokes. Prior art torsional damper couplings have included the use of a rubber element drive shaft that is used to couple the dynamometer to the engine. One type of rubber element drive shaft used commonly in these applications is available commercially from Dana Corporation, Toledo, Ohio under the mark VIBRADAMPS™. However, the use of rubber element drive shafts have number of drawbacks. For example, each rubber element drive shaft has different damping characteristics for use during operation at different engine speed range and require interechanging these rubber element drive shafts one or more times over the course of engine performance testing which is laborious and time-consuming. Additionally, the rubber element drive shafts also vary greatly in their weight and as a results some heavier weight rubber element drive shafts may exceed the bearing load rating on many dynamometers.

To overcome the disadvantages of the prior art rubber element drive shafts, an improved torsional damper coupling was developed. This improved torsional damper coupling included the use of springs that limited the relative rotational movement of two members to provide dampening of torsional vibration. Examples of this type of torsional damper coupling are disclosed in U.S. Pat. No. 5,784,929, entitled “Dynamometer Torsional Damping Apparatus” by Abraham et al., and assigned to the assignee of this application, U.S. Pat. No. 5,831,179, entitled “Combination Dynamometer and Torsional Damping Apparatus,” by Abraham et al., and assigned to the assignee of this application, and U.S. Pat. No. 5,829,320, entitled “Method for Torsional Damping Between a Dynamometer and Prime Mover,” by Abraham et al., and assigned to the assignee of this application, the disclosures of which are incorporated herein by reference.

While the current torsional damper coupling overcomes many of the disadvantages associated with the use of a rubber element drive shaft, further improvements and enhancements can be realized. For example, the current torsional damper coupling uses curved coil springs that are specially made for the torsional damper coupling. Because the curved coil springs are specially made, the cost of these springs is higher than that of readily available off-the-shelf coil springs. The current torsional damper coupling is also limited in the size load which can be applied without increasing the weight and/or overall size of the torsional damper coupling. Additionally, the current torsional damper coupling uses ball bearings to facilitate the relative rotational movement. However, the use of ball bearings has drawbacks in that the ball bearings are susceptible to failure when the torsional damper coupling is exposed to abnormal usage. The current torsional damper coupling also employs a ring with finger projections extending radially from the ring that engage with the springs. These fingers, however, are susceptible to breaking when the torsional damper coupling experiences abnormal wear or abnormal usage. Thus, it would be advantageous to provide a torsional damper coupling that avoids some of the limitations of the currently available torsional damper couplings.

### SUMMARY OF THE INVENTION

The torsional damper coupling of the present invention is capable of handling higher loads while utilizing readily available off-the-shelf springs to provide damping of torsional vibration. The present invention also utilizes a new bearing design which has an improved lifecycle and is less susceptible to failure from exposure to abnormal usage. Additionally, a compression ring is employed that contains pockets to retain the springs and is less susceptible to failure when the torsional damper coupling is exposed to abnormal wear or usage.

A torsional damping coupler according to the principles of the present invention includes a first plate which is rotatable about an axial axis. The first plate has a plurality of recesses that are spaced along the first plate about the axis. The first plate is coupleable to at least one of a prime mover and a dynamometer. A second plate is rotatably coupled to the first plate. The second plate is rotatable about the axis with rotation of the first plate and is also rotatable about the axis relative to the first plate. The second plate has a plurality of openings that are spaced along the second plate about the axis. The second plate is also coupleable to at least one of a prime mover and a dynamometer. A plurality of spring members are at least partially disposed in the openings in the second plate with a portion of at least one of the spring members encircled by one of the openings and the spring members are at least partially disposed in the recesses in the first plate. A third plate is coupled to the first plate with a portion of the second plate disposed between the first and third plates. The spring members are compressed in response to relative rotational movement between the first and second plates. The spring members resist the compression and the resistance dampens torsional vibration between a prime mover and a dynamometer.

In another aspect according to the principles of the present invention, a prime mover testing system is disclosed. The prime mover testing system includes a dynamometer that is operable to measure performance characteristics of a prime mover. The system also includes a torsional damper according to the principles of the present invention that is operable to couple the dynamometer to a prime mover and to dampen the torsional vibration between the dynamometer and the prime mover.

A method of damping torsional vibration between a dynamometer and a prime mover is also disclosed. The method includes: (1) coupling one of the dynamometer and the prime mover to a first member rotatable about an axis, wherein the first member has a plurality of recesses spaced along the first member about the axis; (2) coupling the other of the dynamometer and the prime mover to a second member that is rotatably coupled to the first member, wherein the second member is rotatable about the axis with rotation of the first member, the second member is rotatable about the axis relative to the first member, and the second member has a plurality of openings spaced along the second member about the axis; and (3) damping torsional vibration between the dynamometer and the prime mover by compressing a plurality of spring members in response to relative rotational movement between the first and second members, wherein the spring members are at least partially disposed in the openings with a portion of at least one of the spring members encircled by one of the openings and the spring members being at least partially disposed in the recesses.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a fragmented elevational view of a prime mover testing system using a preferred embodiment of a torsional damper coupling according to the principles of the present invention to test a prime mover;

FIG. 2 is a partial end view of the torsional damper coupling of FIG. 1 taken along line 2-2 of FIG. 1;

FIG. 3 is a partial sectional view of the torsional damper coupling of FIG. 2 taken along line 3-3 of FIG. 2;

FIG. 4 is a partial sectional view of the torsional damper coupling of FIG. 2 taken along line 4-4 of FIG. 2;

FIG. 5 is an exploded assembly view of the torsional damper coupling of FIG. 1;

FIGS. 6A and B are respective front and side elevation views of a preferred embodiment of a bearing according to the principles of the present invention for the torsional damper coupling of FIG. 1;

FIGS. 7A and B are respective side elevation and bottom views of a preferred embodiment of a spring insert according to the principle of the present invention for the torsional damper coupling of FIG. 1; and

FIG. 8 is a partial end view of an alternate torsional damper coupling according to the principles of the present invention showing the use of eight spring members.

### DETAILED DESCRIPTION OF THE PREFERRED EMBODIMENT

The following description of the preferred embodiment is merely exemplary in nature and is in no way intended to limit the invention, its application, or uses.

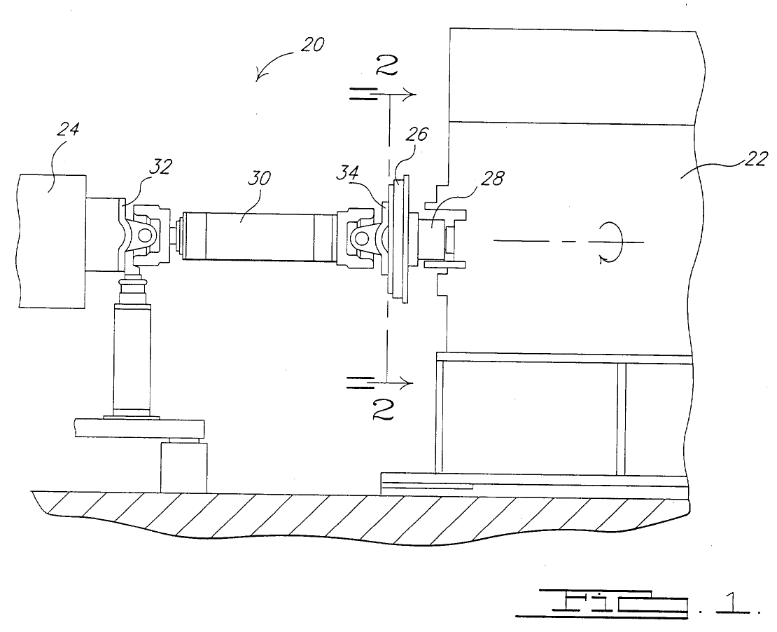

Referring to FIG. 1, a prime mover testing system 20 according to the principles of the present invention is shown testing a prime mover or combustion engine 22. Testing system 20 includes a dynamometer 24 and a torsional damper coupling 26. Torsional damper coupling 26 is coupled, either directly or indirectly, to an output shaft 28 of prime mover 22. A drive shaft 30 is used to couple dynamometer 24 to torsional damper coupling 26. More specifically, a flange 32 on one end of drive shaft 30 is coupled to dynamometer 24 while a flange 34 on an opposite end of drive shaft 30 is coupled to torsional damper coupling 26. Testing system 20 is operable for measuring a variety of engine or prime mover performance parameters over a wide range of operating speeds and loading conditions.

Although testing system 20 and torsional damper coupling 26 are disclosed in the context of a combustion engine dynamometer test cell arrangement, the present invention is applicable to dynamometers coupled to any type of rotating machinery, which is referred to herein generally as a prime mover. Still more generally, however, many of the features, aspects and advantages of the invention are applicable to the coupling of any two or more rotatable members, which rotate about a common axis.

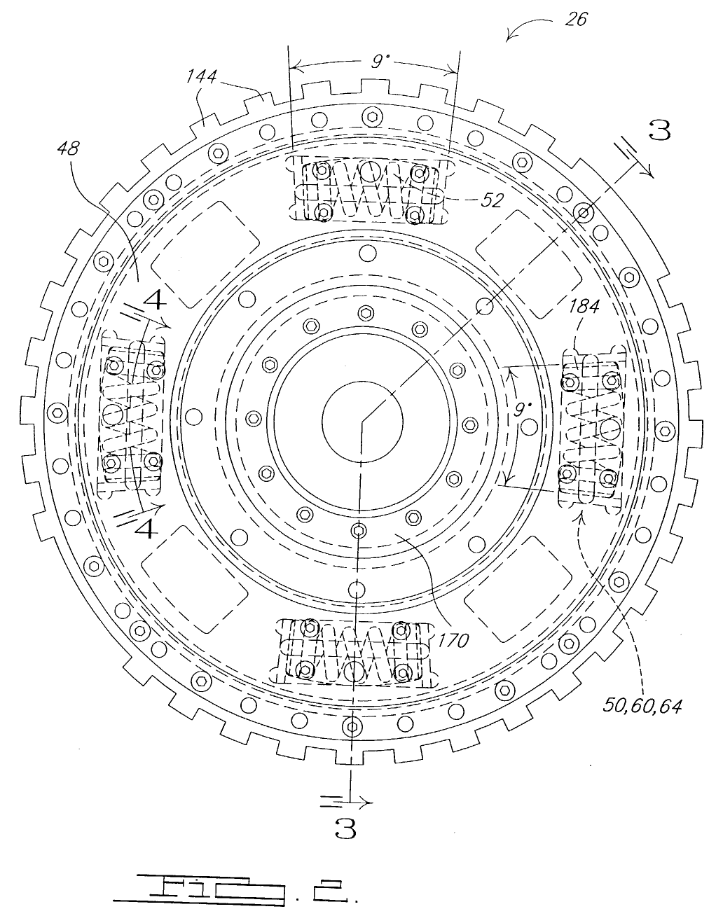

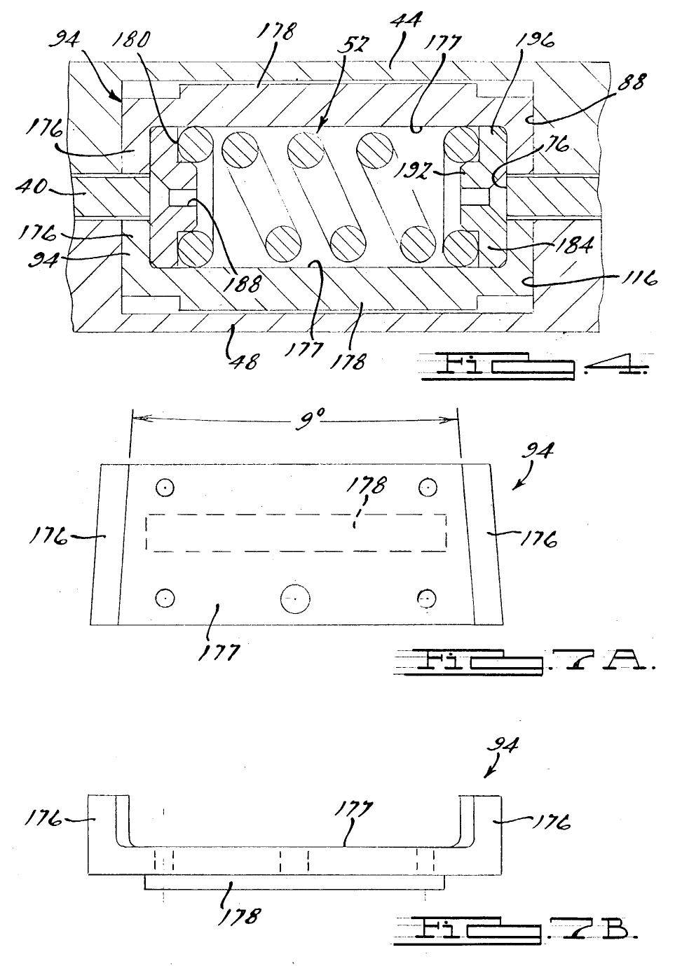

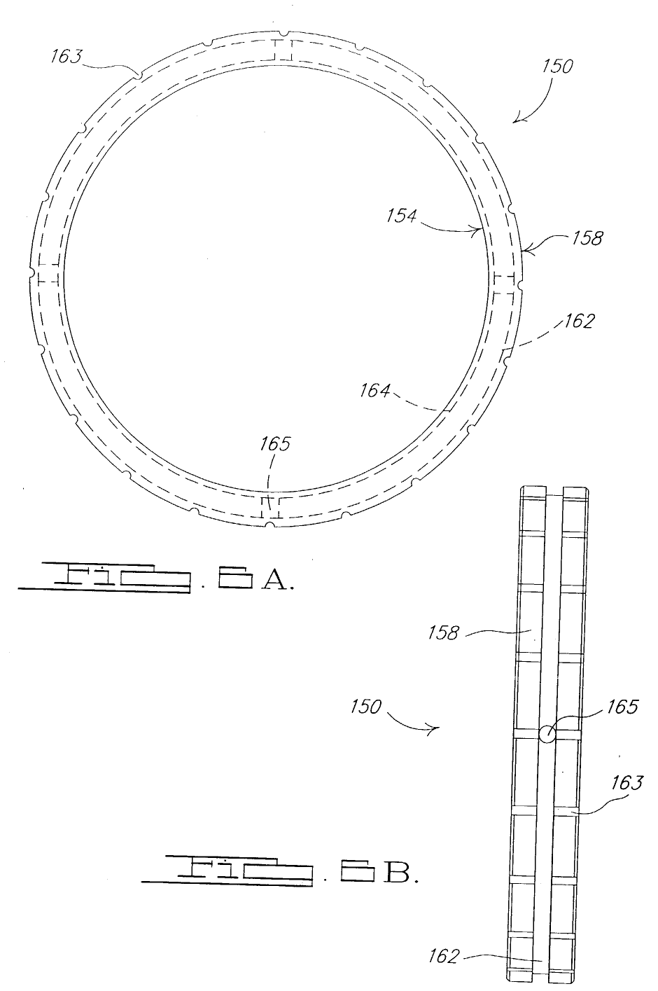

Referring now to FIGS. 2-7B, the preferred embodiment of torsional damper coupling 26 according to the principles of the present invention is illustrated. Torsional damper coupling 26 generally comprises a compression member 40 which is rotatably coupled to a body member 44 and partially disposed between body member 44 and a cover member 48. Compression member 40 is capable of rotating with rotation of body member 44 and capable of rotation relative to body member 44. Cover member 48 is removeably fixedly attached to body member 44 such that cover member 48 rotates with rotation of body member 44 and no relative rotation between body member 44 and cover member 48 occurs. A plurality of spring members 52 are partially disposed in recesses 56 in body member 44, partially disposed in openings 60 in compression member 40 and partially disposed in recesses 64 in cover member 48. Compression member 40 and body and cover members 44 and 48 are engageable to compress spring members 52, which are interconnected therebetween, in response to relative rotational movement between compression member 40 and body and cover members 44 and 48 about a common rotation axis to dampen torsional vibrations therebetween, as described below

Compression member 40 is generally ring-shaped with a central opening 65 defined by an inner peripheral wall 66. Compression member 40 has a first portion 68 with a first axial thickness and a second portion 72 with a second axial thickness greater than the first axial thickness of first portion 68. Second portion 72 is located radially outwardly from and completely encircles first portion 68. Openings 60 are spaced along second portion 72 of compression member 40 about the rotation axis. Preferably, openings 60 are equally spaced along compression member 40 about the rotation axis. Each opening 60 has opposing end walls 78 and radially opposing side walls 80. Openings 60 are dimensioned so that each spring member 52 is partially disposed in an opening 60 and completely encircled by end walls 76 and side walls 80 with portions of each spring member 52 extending axially beyond second portion 72 on both sides of compression member 40. End walls 76 are engageable with opposing ends of spring members 52 to limit relative rotation between compression member 40 and body and cover members 44 and 48 and to dampen torsional vibration, as described below. Compression member 40 has two recessed fittings 81 on first portion 68 to allow lubricant to be inserted into torsional damper coupling 26, as described below. Compression member 40 has a plurality of bolt holes 82 spaced along first portion 68 about the rotation axis for attaching to flange 34 which can be attached to drive shaft 30, as shown, or, alternatively, can be attached to output shaft 28 of prime mover 22. Thus, compression member 40 can be coupled to either of prime mover 22 and dynamometer 24. Preferably, compression member 40 is coupled to dynamometer 24.

As stated above, body member 44 has a plurality of recesses 56 in which spring members 52 are partially disposed. Recesses 56 are spaced along body member 44 about the rotation axis in an orientation that allows recesses 56 in body member 44 to be capable of being substantially aligned with openings 60 in compression member 40. Each recess 56 has opposing end walls 88 and radially opposing side walls 90. Opposing end walls 88 of each recess 56 in body member 44 taper away from one another slightly as end walls 88 extend radially outwardly. Preferably, end walls 88 taper away from one another at an included angle of about 9°. Each recess 56 has a channel 92 that extends between end walls 88 for receiving a complementary portion of an insert 94 that is positioned in each recesses 56. Recesses 56 have bolt holes 95 to secure each insert 94 in recesses 56 with a bolt. Recesses 56 are dimensioned to receive inserts 92 and so that spring members 52 are partially disposed in recess 56 and a portion of each spring member 52 is completely encircled by end walls 88 and side walls 90. End walls 88 are operable to exert a force on opposing ends of spring members 52 through inserts 92 to limit relative rotation between body member 44 and compression member 40 and to dampen torsional vibration, as described below.

Body member 44 has an annular groove 96 that is located radially inwardly from recesses 56. Annular groove 96 is dimensioned to receive a part of first portion 66 of compression member 40. Body member 44 has a plurality of openings 100 spaced along body member 44 about the rotation axis adjacent the outer periphery of body member 100 for attaching cover member 48, as described below. Body member 44 has a hub portion 104 that resides in central opening 65 of compression member 40.

As stated above, cover member 48 has a plurality of recesses 64 in which spring members 52 are partially disposed. Recesses 64 are spaced along cover member 48 about the rotation axis in an orientation that allows recesses 64 in cover member 48 to be substantially aligned with recesses 56 in body member 44 when cover member 48 is attached to body member 44. Recesses 64 have opposing end walls 116 and radially opposing side walls 120. Opposing end walls 116 of each recess 64 in cover member 48 taper away from one another slightly as end walls 116 extend radially outwardly. Preferably, end walls 116 taper away from one another at an included angle of about 9°. Each recess 64 has a channel 122 that extends between end walls 116 for receiving a complementary portion of inserts 94 which are positioned in each recess 64. Recesses 64 have bolt holes 123 to serve each insert 94 in recess 64 with a bolt. Recesses 64 are dimensioned to receive inserts 92 and so that spring members 52 are partially disposed in recesses 64 and a portion of each spring member 52 is completely encircled by end walls 116 and side walls 120. End walls 116 are operable to exert a force opposing ends of spring members 52 through inserts 92 to limit rotational movement of compression member 44 relative to cover member 48 about the rotation axis and to dampen torsional vibration, as described below. Cover member 48 also serves to retain spring members 52 within openings 60 in compression member 40.

Cover member 48 also has a central opening 124 that is dimensioned to encircle a portion of the periphery of first portion 68 of compression member 40. Cover member 48 has a plurality of openings 128 spaced along cover member 48 about the rotation axis adjacent the outer periphery of cover member 48. Openings 128 are configured to align with openings 100 in body member 44. Bolts 132 are used to secure cover member 48 to body member 44 and also to secure a mounting flange 136 to body member 44. That is, mounting flange 136 has a plurality of threaded holes 138 and body member 44 is disposed between mounting flange 136 and cover member 48 such that mounting flange 136, body member 44, and cover member 48 are all fixed relative to one another and rotate as a single component when attached together with bolts 132.

Mounting flange 136 is configured with a plurality of openings 140 in a pattern to allow mounting flange 136 to be attached to at least one of flange 34 on drive shaft 30 and input shaft 28 of dynamometer 24. Thus, mounting flange 36 enables cover member 48, body member 44, and mounting flange 136 to be coupled to either prime mover 22 via output shaft 28 and/or dynamometer 24 via flange 34 on drive shaft 30. Preferably, mounting flange 136, body member 44 and cover member 48 are coupled to prime mover 22. Mounting flange 136 has a plurality of projections 144 along its outer peripheral edge that extend radially outwardly. Projections 144 can be used to measure rotational speed, to coordinate with the firing sequence of prime mover 22, and to interact with a starter on prime mover 22.

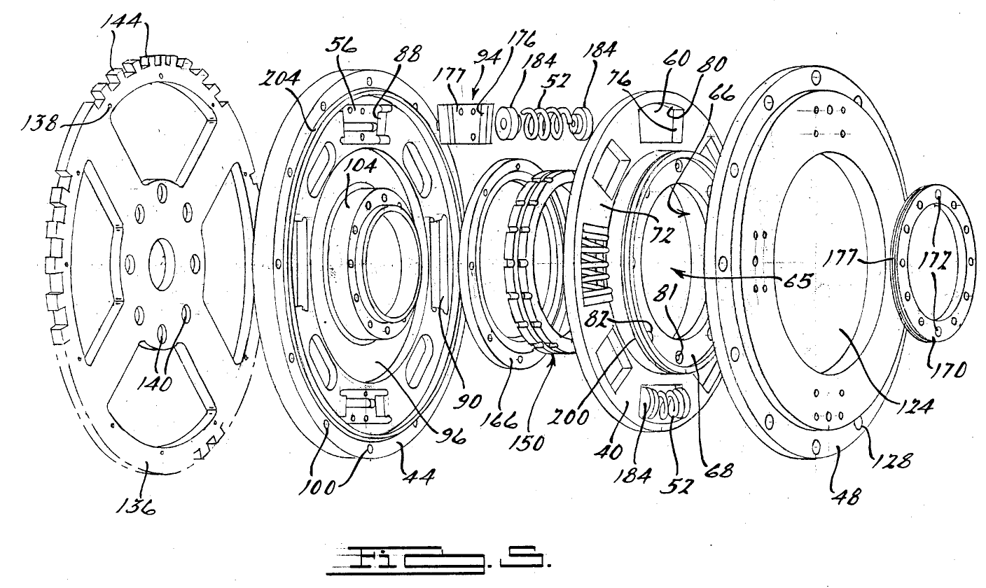

A bearing 150 is disposed between body member 44 and compression member 40 to provide a low friction surface to facilitate relative rotational movement between compression member 40 and body member 44. As can best be seen in FIGS. 5A and B, bearing 150 is a solid ring bearing with an inner peripheral wall 154 and an outer peripheral wall 158. Bearing 150 is dimensioned so that inner peripheral wall 154 engages with hub portion 104 of body member 44 and outer peripheral wall 158 engages with inner peripheral wall 66 of compression member 40. Outer peripheral wall 158 of bearing 150 has an annual groove 162 that is substantially centered in outer peripheral wall 158. A plurality of axial grooves 163 extend axially across outer peripheral wall 158. Inner peripheral wall 154 has an annular groove 164 that is substantially centered in inner peripheral wall 154. A plurality of openings 165 extend radially between annular grooves 162 and 163. Annular grooves 162 and 164 and axial grooves 163 are lubricant channels that receive a lubricant via fittings 81 to facilitate relative rotational movement between bearing 150 and compression member 40. Openings 165 allow lubricant to pass between annular grooves 162 and 164. Bearing member 150 is retained between compression member 40 and body member 44 by first and second retaining rings 166 and 170. First retaining ring 168 is attached to compression member 40 and retains bearing 150 to compression member 40. Second retaining ring 170 is attached to body member 44 and retains bearing 150 to body member 44. Thus, first and second retaining rings 166 and 170 and bearing 150 serve to couple compression member 40 to body member 44. Second retaining ring 170 has a pair of openings 172 that area aligned with and allow access to fittings 81 for adding lubricant. Second retaining ring 170 has an annular groove along its outer peripheral edge for receiving an annular seal 174, in this case in the form of an O-ring , that seals against inner periphery wall 66 of compression member 40. Annular seal 174 prevents seepage of lubricant, which has a tendency to become viscous when heated, out of recesses 56 and 64 in the respective body and cover members 44 and 48 and from bearing 150.

As stated above, bearing 150 is a solid ring type bearing. Bearing 150 needs to be capable of withstanding the wear associated with the relative rotational movement between compression member 40 and body member 44. To provide the necessary wear characteristics, bearing 150 is preferably made from Ampco Bronze #18. It should be understood, however, that bearing 150 can be made from different materials having similar characteristics as Ampco Bronze #18 and still be within the scope of the present invention.

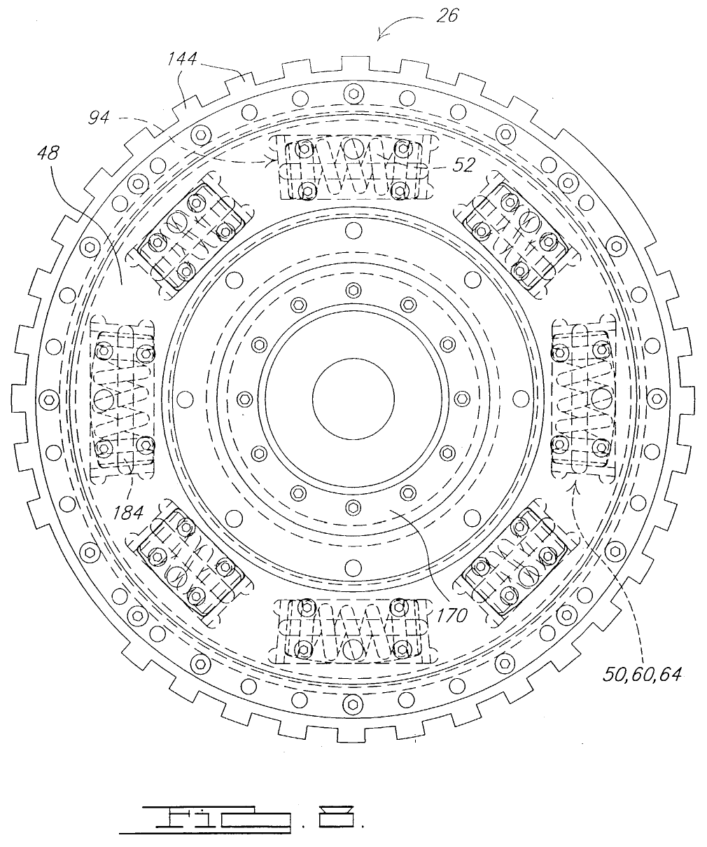

As shown in FIGS. 7A and B, each insert 94 has opposing end walls 176 and a base wall 177 extending therebetween and forming a generally U-shaped insert 94. A projection 178 extends along base wall 177 and is complementary to channels 92 and 122 in the respective body and cover members 44 and 48. There are a plurality of threaded cavities that align with bolt holes 95 and 123 on the respective body and cover members 44 and 48 for receiving complementary threaded bolts to retain inserts 94 in recesses 56 and 64. End walls 176 taper slightly away from one another as end walls 176 extend radially outwardly. Preferably, end walls 176 taper away from one another at an included angle of about 9°. Inserts 94 are dimensioned to fit within recesses 56 and 64 with end walls 176 positioned against end walls 88 and 116 in the respective body and cover members 44 and 48. Inserts 94 are also dimensioned to receive a portion of spring members 52 with end walls 176 engaging with opposing ends 180 of spring members 52 via end caps 184, as described below. Inserts 94 provide a surface over which spring members 52 will travel when torsional damper coupling 26 is damping torsional vibrations between prime mover 22 and dynamometer 24, as described below. Preferably, inserts 94 are made from a hardened steel. Even more preferably, inserts 94 are made from a carburized hardened and ground 1020 steel. However, it should be appreciated that other materials having similar characteristics can be employed without departing from the scope of the present invention.

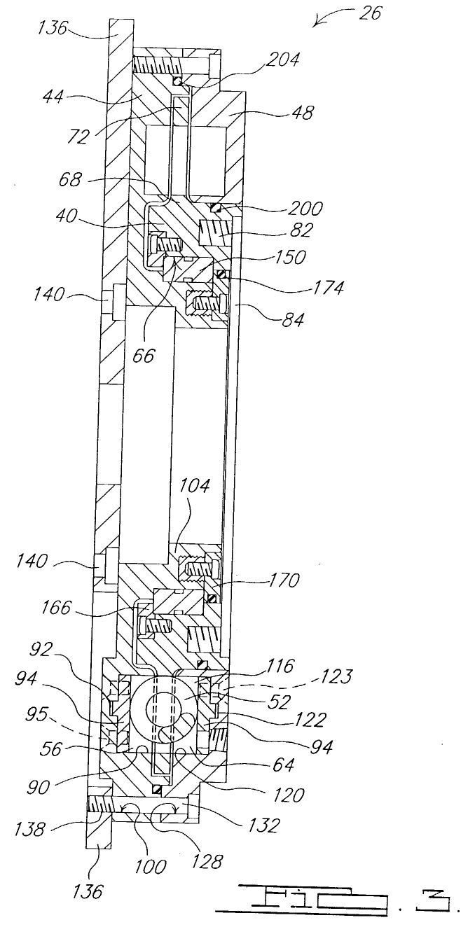

As shown in FIGS. 3-5 spring members 52 are in the form of coil springs that each have opposing ends 180. End caps 184 are disposed on each end 180 of each spring member 52. Specifically, each end cap 184 has a hub portion 192, which fits within ends 180 of spring members 52, and a base portion 196 which engages with end walls 176 in inserts 94 and end walls 76 in compression member 40. End caps 184 provide a contact surface for engaging end walls 76, and 176 in the respective compression member 40 and inserts 94. The tapering of end walls 176 of inserts 94 in conjunction with end caps 184 provide for a more uniform force distribution on ends 180 and throughout the coils of spring members 52 when spring members 52 are being compressed. That is, because compression member 40 rotates relative to body and cover members 44 and 48 when damping torsional vibrations, compression of spring members 52 will tend to cause spring members 52 to bow and may cause a portion of ends 180 of spring members 52 or end caps 184 to disengage from a portion of end walls 176 and insert 94. Thus, end walls 176 of inserts 94 are tapered to compensate for this potential disengagement and keep end caps 184 square against end walls 176. Each end cap 184 has an opening 188 for facilitating lubricant flow. Spring members 52 have a length that requires spring members 52 to be slightly precompressed to fit within openings 60 in compression member 40 and within recesses 56 and 64 in the respective body and cover members 44 and 48. The requirement to precompress spring members 52 prevents spring members 52 from moving around or oscillating within opening 60 and/or recesses 56 and 64 in the respective body and cover members 44 and 48.

Spring members 52 of various ratings or sizes can be used to provide differing damping characteristics for torsional damper coupling 26. That is, different spring compression rates can be used to alter the vibrational damping characteristics of torsional damper coupling 26. For example, each spring member 52 can be rated between approximately 265 lbs./in. and 3190 lbs./in. which rating may be more or less depending on the particular application for which torsional damper coupling 26 is to be used. Such spring members 52 are readily available as off-the-shelf die springs from Danly Die Set of Chicago, Ill. Spring members 52 are preferably coated with a lubricant to reduce frictional contact between spring members 52 and inserts 94 during movement of the spring members.

Cover member 48 is readily removable from body member 44 to permit adding, removing, and interchanging spring members 52 to change damping characteristics of torsional damper coupling 26. Preferably, torsional damper coupling 28 contains at least four spring members 52 that are evenly spaced about the rotation axis in the corresponding recesses 56 and 64 of the respective body and cover members 44 and 48, and openings 60 of compression member 40.

An annular seal 200 is disposed between an annular groove in a peripheral edge of first portion 68 of compression member 40 and the inner peripheral wall defining the central opening 124 of cover member 48. Annular seal 200 prevents seepage of any lubricant, which has a tendency to become viscous when heated, out of recesses 56 and 64. In the preferred embodiment, annular seal 200 is an annular quad-ring available from the Zatkoff Seals and Packings of Detroit, Mich. Another annular seal 204 is disposed between cover member 48 and body member 44. Annular seal 204, in this case in the form of an O-ring, also prevents seepage of any lubricant, out of recesses 56 and 64.

A lubricant is provided in torsional damper coupling 26 to facilitate relative movement between the various components and to minimize friction or heat buildup. The lubricant is inserted into torsional damper coupling 26 via fittings 81 on compression member 40. The lubricant travels through fittings 81 and disburses along bearing 150 and throughout openings 60 in compression member 40 and recesses 56 and 64 in the respective body and cover members 44 and 48. The lubricant also coats and encapsulates spring members 52. A variety of lubricants can be used in torsional damper coupling 26. Preferably, the lubricant is Mobil One Synthetic Universal Grease.

To use torsional damper coupling 26, body member 44 is coupled to either of prime mover 22 or dynamometer 24. Specifically, mounting flange 136 is mounted to either of output shaft 28 of prime mover 22 or drive shaft 30 which is coupled to dynamometer 24. Compression member 40 is coupled to the other of prime mover 22 and dynamometer 24 to which body member 44 is not coupled. Specifically, compression member 40 is mounted to flange 34 which is mounted to either drive shaft 30 or output shaft 28 of prime mover 22. Preferably, body member 44 is coupled to prime mover 22 while compression member 40 is coupled to dynamometer 24. For brevity, torsional damper coupling 26 will be discussed with compression member 40 coupled to dynamometer 24 and body member 44 coupled to prime mover 22. However, it should be understood that torsional damper coupling 26 can be configured with compression member 40 coupled to prime mover 22 and body member 46 coupled to dynamometer 24 without departing from the spirit and scope of the present invention.

Once torsional damper coupling 26 is coupled to both prime mover 22 and dynamometer 24, prime mover 22 can be operated to provide rotation of output shaft 28 and prime mover 22 can be tested by dynamometer 24. The initiation of rotation of output shaft 28 by prime mover 22 causes body member 44 to rotate relative to compression member 40 about the common rotation axis. The relative rotation between compression member 40 and body member 44 will be resisted by spring members 52 which are compressed by an end wall 76 of each opening 60 engaging with an end cap 184 on one end of spring members 52 while an end cap 184 on an opposing end of each spring member 52 engages with end walls 176 of inserts 94 in body and cover members 44 and 48. The resistance of spring members 52 to the compression causes spring members 52 to exert a force on end walls 176 of inserts 94 which is transferred to end walls 88 and 116 of the respective body and cover members 44 and 48 and to exert an opposing force on end walls 76 of compression member 40. The force exerted by spring members 52 on compression member 40 causes compression member 40 to also rotate about the common rotation axis with the rotation of body member 44. The rotation of compression member 40 is transferred to dynamometer 24 via shaft 30. Thus, rotation of output shaft 28 by prime mover 22 is translated into rotation of shaft 30 and transferred to dynamometer 24.

Prime mover 22 is then operated at varying loads and speeds, as desired, to test various characteristics and performance of prime mover 22. During operation, prime mover 22 will have pulses or spikes in the torsional output applied to output shaft 28. These pulses or spikes cause torsional vibrations in the rotational output and are dampened by torsional damper coupling 26. Specifically, the torsional vibrations transmitted from prime mover 22 to torsional damper coupling 26 via output shaft 28 are translated into rotation of body and cover members 44 and 48 relative to compression member 40. The spring members 52 act against the rotation of body and cover members 44 and 48 relative to compression member 40. The resistance to the relative rotation will vary depending upon the size and strength of spring members 52 that are employed in torsional damper coupling 26. That is, when the expected torque loads produced by prime mover 22 are relatively small, smaller or lighter duty spring members 52 can be used to dampen torsional vibrations while larger or heavier duty spring members 52 can be used to provide damping of torsional vibrations when relatively higher torque loads are expected to be produced by prime mover 22. Preferably, spring members 52 that are chosen will be compressed no more than about one-third of their uncompressed length to maximize the lifespan of spring members 52. That is, the lifespan of spring members 52 can be maximized by selecting spring members 52 that are compressed only about one-third of their overall uncompressed length during operation of torsional damper coupling 26 to dampen torsional vibrations. The compression of spring members 52 approximately one-third of their uncompressed length results in an relative rotation of compression member 40 relative to body and cover members 44 and 48 of about 9°. Thus, torsional damper coupling 26 is preferably operated such that compression member 40 rotates relative to body and cover members 44 and 48 a maximum of about 9° which translates into a compression of spring members 52 of a maximum of about one-third of their uncompressed length. Accordingly, the damping characteristics of torsional damper coupling 26 can be varied by providing spring members 52 of varying sizes and spring rates.

The resistance of spring members 52 to relative rotation between compressing member 40 and body and cover members 44 and 48, while allowing some brief temporary relative rotational movement between compression member 40 and body and cover members 44 and 48, will cause compression member 40 and body and cover members 44 and 48 to become in sync again (barring any additional torsional vibrations) wherein compression member 40 and body and cover members 44 and 48 rotate together about the common rotation axis with no relative rotation therebetween. As further torsional vibrations of prime mover 22 are transmitted to torsional damper coupling 26, body and cover members 44 and 48 will again rotate relative to compression member 40 and allow spring members 52 to absorb and dampen the torsional vibration. Thus, torsional damper coupling 26 is capable of dampening torsional vibration and pulses produced by prime mover 22.

Torsional damper coupling 26 is operable over a wide range of rotational speeds. For example, torsional damper coupling 26, depending upon the size and spring rate of spring members 52 and the rotational torque produced by prime mover 22, can be operated at rotational speeds of just above 0 rpm to greater than 10,000 rpm. The ability to select various size spring members 52 with various spring rates enables torsional damper coupling 26 to be operated at greater than 10,000 rpm for prime movers 22 producing various torque outputs at those rpms and effectively damping torsional vibration and pulses produced by prime mover 22. Preferably, torsional damper coupling 26 uses four spring members 52 that are equally spaced about the common rotation axis. However, it should be understood that more than four springs can be used in torsional damper coupling 26 without departing from the scope of the present invention. For example, as shown in FIG. 8, torsional damper coupling 26 can employ at least eight spring members 52 equally spaced about the common rotation axis. If desired, more than eight spring members 52 can also be employed. The spacing of the spring members should be equal about the common rotation axis to equally distribute the mass of torsional damper coupling 26 about the common rotation axis and to minimize the need for balancing the torsional damper coupling 26 or encountering an out-of-balance condition at the various rotational speeds to be encountered.

Preferably, torsional damper coupling 26 is of a low weight to reduce and/or minimize the stress on bearings supporting input shaft 28 of dynamometer 24. To provide a torsional damper coupling 26 of a low weight, it is preferred that body and cover members 44 and 48 be made from aluminum or some other lightweight material while compression member 40 is made from a steel material or some other relatively strong material which will withstand the forces exerted thereon in operation of torsional damper coupling 26. In the preferred embodiment, torsional damper coupling 26 weighs between about 25 pounds to about 70 pounds. This relatively light weight reduces the load on the dynamometer input shaft 28, which in turn reduces wear on dynamometer 24.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A torsional damping apparatus that dampens torsional vibration between a prime mover and a dynamometer, the apparatus comprising:
a first plate rotatable about an axial axis, said first plate having a plurality of recesses that are spaced along said first plate about said axis and said first plate being coupleable to at least one of a prime mover and a dynamometer;
a second plate rotatably coupled to said first plate with said second plate being rotatable about said axis with rotation of said first plate and being rotatable about said axis relative to said first plate, said second plate having a plurality of openings that are spaced along said second plate about said axis and said second plate being coupleable to at least one of a prime mover and a dynamometer;
a plurality of spring members at least partially disposed in said openings in said second plate with a portion of at least one of said spring members encircled by one of said openings and said spring members being at least partially disposed in said recesses in said first plate;
a third plate coupled to said first plate with a portion of said second plate disposed between said first and third plates; and
wherein said spring members are compressed in response to relative rotational movement between said first and second plates, said spring members resisting said compression and said resistance damping torsional vibration between a prime mover and a dynamometer.

2. The apparatus of claim 1, further comprising a solid ring bearing disposed between a portion of said first plate and a portion of said second plate, and wherein at least one of said first and second plates rotates relative to said bearing during relative rotation between said first and second plates.

3. The apparatus of claim 2, wherein said bearing has an outer periphery with an annular groove and an inner periphery with an annular groove for receiving a lubricant.

4. The apparatus of claim 2, wherein said outer periphery of said bearing contacts said second plate.

5. The apparatus of claim 2, wherein said bearing is made from Ampco Bronze #18.

6. The apparatus of claim 1, wherein said plurality of recesses are at least four recesses, said plurality of openings are at least four openings, and said plurality of spring members are at least four spring members.

7. The apparatus of claim 6, wherein said plurality of recesses are at least eight recesses, said plurality of openings are at least eight openings, and said plurality of spring members are at least eight spring members.

8. The apparatus of claim 1, wherein said second plate has a first portion with a first axial thickness and a second portion with a second axial thickness greater than said first axial thickness, and said openings are spaced along said second portion of said second plate about said axis.

9. The apparatus of claim 8, wherein said second portion is located radially outwardly from said first portion.

10. The apparatus of claim 1, wherein end walls of said recesses in said first plate and end walls of said openings in said second plate exert a compressive force on said spring members during relative rotational movement between said first and second plates.

11. The apparatus of claim 10, wherein said compressive force is exerted on opposing ends of said spring members.

12. The apparatus of claim 1, further comprising a plurality of inserts disposed in said recesses in said first plate and wherein said spring members are partially disposed in said inserts.

13. The apparatus of claim 1, wherein:
said third plate has a plurality of recesses that are spaced along said third plate about said axis and said recesses in said third plate being substantially aligned with and opposing said recesses in said first plate; and
said spring members are at least partially disposed in said recesses in said third plate.

14. The apparatus of claim 1, wherein said spring members are coil springs.

15. The apparatus of claim 1, further comprising a plurality of end caps disposed on said ends of each spring.

16. The apparatus of claim 1, wherein said spring members are operable to provide torsional damping at rotational speeds in excess of 10,000 rpm.

17. The apparatus of claim 1, wherein said spring members have an uncompressed length and said spring members are compressed a maximum of about one-third of said uncompressed length during relative rotation between said first and second plates.

18. The apparatus of claim 1, wherein said first and third plates are made of aluminum and said second plate is made of steel.

19. The apparatus of claim 1, wherein each of said spring members has a portion that is encircled by one of said openings.

20. A prime mover testing system comprising:
a dynamometer operable to measure performance characteristics of a prime mover; and
a torsional damper operable to couple said dynamometer to a prime mover, said torsional damper damping torsional vibration between said dynamometer and a prime mover, said torsional damper comprising:
a body member rotatable about an axis, said body member having a plurality of recesses that are spaced along said body member about said axis and said body member being coupleable to at least one of a prime mover and said dynamometer;
a compression member rotatably coupled to said body member with said compression member being rotatable about said axis with rotation of said body member and being rotatable about said axis relative to said body member, said compression member having a plurality of openings that are spaced along said compression member about said axis and said compression member being coupleable to at least one of a prime mover and said dynamometer;
a plurality of spring members at least partially disposed in said openings in said compression member with a portion of at least one of said spring members surrounded by one of said openings and said spring members being at least partially disposed in said recesses in said body member;
a cover member coupled to said body member with a portion of said compression member disposed between said body and cover members; and
wherein said spring members are compressed in response to relative rotational movement between said body and compression members, said spring members resisting said compression and said resistance damping torsional vibration between a prime mover and said dynamometer.

21. The system of claim 20, wherein said plurality of recesses are at least four recesses, said plurality of openings are at least four openings, and said plurality of spring members are at least four spring members.

22. The system of claim 21, wherein said plurality of recesses are at least eight recesses, said plurality of openings are at least eight openings, and said plurality of spring members are at least eight spring members.

23. The system of claim 20, wherein end walls of said recesses in said body member and end walls of said openings in said compression member exert a compressive force on said spring members during relative rotational movement between said body and compression members.

24. The apparatus of claim 23, wherein said compressive force is exerted on opposing ends of said spring members.

25. The system of claim 20, wherein said spring members have an uncompressed length and said spring members are compressed a maximum of about one-third of said uncompressed length during relative rotational movement between said body member and said compression member.

26. The apparatus of claim 20, further comprising a plurality of inserts disposed in said recesses in said body m

27. The system of claim 20, wherein:
said cover member has a plurality of recesses that are spaced along said cover member about said axis and said recesses in said cover member being substantially aligned with and opposing said recesses in said body member; and
said spring members are at least partially disposed in said recesses in said cover member.

28. The system of claim 20, further comprising a solid bushing disposed between a portion of said body member and a portion of said compression member, and wherein at least one of said body and compression members rotates relative to said bushing during relative rotation between said body and compression members.

29. The apparatus of claim 20, wherein said torsional damper is operable to provide torsional damping at rotational speeds of greater than 10,000 rpm.

30. The apparatus of claim 20, wherein each of said spring members has a portion that is surrounded by one of said openings.

31. A method of damping torsional vibration between a dynamometer and a prime mover, the method comprising:
(a) coupling one of the dynamometer and the prime mover to a first member rotatable about an axis, wherein said first member has a plurality of recesses spaced along said first member about said axis;
(b) coupling the other of the dynamometer and the prime mover to a second member that is rotatably coupled to said first member, wherein said second member is rotatable about said axis with rotation of said first member, said second member is rotatable about said axis relative to said first member, and said second member has a plurality of openings spaced along said second member about said axis; and
(c) damping torsional vibration between the dynamometer and the prime mover by compressing a plurality of spring members in response to relative rotational movement between said first and second members, wherein said spring members are at least partially disposed in said openings with a portion of at least one of said spring members encircled by one of said openings and said spring members being at least partially disposed in said recesses.

32. The method of claim 31, wherein step (c) includes exerting a compressive force on said spring members with end walls in said recesses in said first member and with end walls in said openings in said second member.

33. The method of claim 32, wherein step (c) includes exerting said compressive force on opposing ends of said spring members.

34. The method of claim 31, wherein step (c) includes compressing said spring, members a maximum distance of about one-third of and an uncompressed length of said spring members when damping torsional vibration.

35. The method of claim 31, further comprising rotating at least one of said first and second members in excess of 10,000 rpm.

36. The method of claim 31, further comprising rotatably coupling said second member to said first member with a solid ring bearing that allows at least one of said first and second members to rotate about said axis relative to said bearing.

37. The method of claim 31, further comprising retaining said spring members in said recesses and in said openings with a third member coupled to said first member, wherein a portion of said second member is disposed between said first and third members and said spring members are at least partially disposed in recesses in said third member that are spaced along said third member about said axis and substantially aligned with and opposing said recesses in said first member.

38. The method of claim 31, wherein step (c) further comprises compressing a plurality of coil springs.
